(19) United States
(12) Patent Application Publication
(10) Pub. No.: US 2013/0314656 A1
(43) Pub. Date: Nov. 28, 2013

(54) Liquid Crystal Panel And Method Of Liquid Crystal Alignment

(71) Applicants: Xiaolong Ma, Shenzhen (CN); Hong-Ji Huang, Shenzhen (CN)

(72) Inventors: Xiaolong Ma, Shenzhen (CN); Hong-Ji Huang, Shenzhen (CN)

(73) Assignee: SHENZHEN CHINA STAR OPTOELECTRONICS TECHNOLOGY CO LTD, Shenzhen (CN)

(21) Appl. No.: 13/521,738

(22) PCT Filed: May 30, 2012
(86) PCT No.: PCT/CN12/76258

§ 371 Date: Jul. 11, 2012

(30) Foreign Application Priority Data
May 22, 2012 (CN) 201210160430.0

(51) Int. Cl. G02F 1/1337

(52) U.S. Cl. 349/127; 349/187

(57) ABSTRACT

The present invention provides a method of liquid crystal (LC) alignment and LC panel, which includes: providing first substrate, forming first alignment film on surface of first substrate; providing second substrate, disposed oppositely to first substrate, and forming common electrodes, pixel electrodes disposed with separating space, and second alignment film covering common electrodes and pixel electrodes on surface of second substrate; filling LC composite between first alignment film and second alignment film, LC composite comprising reactive monomers and LC molecules; applying high frequency alternating electric field to common electrodes and pixel electrodes so that reactive monomers and LC molecules arranged perpendicular to high frequency alternating electric field with pretilt angle; continuing applying high frequency alternating electric field and using UV radiation to fix pretilt angle to perform alignment. The present invention does not use rubbing to perform alignment, and avoids pollution to LC panel.

### BACKGROUND OF THE INVENTION

1. Field of the Invention

The present invention relates to the field of liquid crystal displaying techniques, and in particular to a liquid crystal panel and method of liquid crystal alignment.

2. The Related Arts

Liquid crystal panel comprises a thin film transistor (TFT) array substrate and a color filter (CF) substrate. Inner surfaces of TFT substrate and CF substrate facing each other comprise transparent electrodes, and liquid crystal fills the space between TFT substrate and CF substrate. The liquid crystal panel applies electric field through transparent electrodes to control the orientation of liquid crystal to change photo-polarization and to realize optical penetration and blockage through photo polarizer to accomplish displaying.

Currently, based on the initial layout of liquid crystal and the activity of liquid crystal in the electric field, the liquid crystal panel can be divided into twisted nematic (TN), vertical alignment (VA), and in panel switching (IPS) display modes; wherein because IPS display mode has advantages of high contrast and fast response time, IPS is widely adopted in liquid crystal panels.

When adopting IPS display mode during manufacturing liquid crystal panel, an initial alignment must be performed on liquid crystal. The known techniques usually perform liquid crystal alignment through rubbing alignment, which comprises: using contact roller with raised texture to roll and rub the alignment film disposed on surfaces of TFT substrate and CF substrate to form a pretilt angle of same direction on alignment film so that liquid crystal molecules are arranged towards the same direction with a pretilt angle to show consistent optical characteristics. However, rubbing alignment may cause grain pollution on alignment film and degrade the yield rate. Also, rubbing alignment will cause static electricity to damage transistors and leads to defects in liquid crystal panel.

### SUMMARY OF THE INVENTION

The technical issue to be addressed by the present invention is to provide a liquid crystal panel and method of liquid crystal alignment to avoid rubbing alignment causing pollution and defects on liquid crystal panel.

The present invention provides a method of liquid crystal alignment,

which comprises: providing a first substrate, and forming a first alignment film on surface of the first substrate; providing a second substrate, disposed oppositely to the first substrate, and forming common electrodes and pixel electrodes disposed with separating space, and a second alignment film covering common electrodes and pixel electrodes on surface of the second substrate; filling liquid crystal composite between the first alignment film and the second alignment film, the liquid crystal composite comprising reactive monomers and liquid crystal molecules, wherein liquid crystal molecules showing negative liquid crystal characteristics in high frequency alternating electric field, and arranged with long axis direction of liquid crystal molecules being perpendicular to direction of high frequency alternating electric field; reactive monomers arranged with long axis direction of reactive monomers being perpendicular to high frequency alternating electric field, and reactive monomers in high frequency alternating electric field forming liquid crystal alignment polymers and polymers being deposited on surfaces of the first alignment film and the second alignment film after radiation of UV light; applying high frequency alternating electric field to common electrodes and pixel electrodes so that reactive monomers and liquid crystal molecules being arranged perpendicular to high frequency alternating electric field with pretilt angle; continuing applying high frequency alternating electric field and using UV light for radiation so that reactive monomers polymerizing and polymers deposited on surfaces of the first alignment film and the second alignment film leading to fixing pretilt angle to perform alignment on liquid crystal molecules.

According to a preferred embodiment of the present invention, the pretilt angle is 0-5°.

According to a preferred embodiment of the present invention, frequency of high frequency alternating electric filed is equal to or higher than 1000 Hz.

The present invention provides a method of liquid crystal alignment, which comprises: providing a first substrate, and forming a first alignment film on surface of the first substrate; providing a second substrate, disposed oppositely to the first substrate, and forming common electrodes and pixel electrodes disposed with separating space, and a second alignment film covering common electrodes and pixel electrodes on surface of the second substrate; filling liquid crystal composite between the first alignment film and the second alignment film, the liquid crystal composite comprising reactive monomers and liquid crystal molecules; applying high frequency alternating electric field to common electrodes and pixel electrodes so that reactive monomers and liquid crystal molecules being arranged perpendicular to high frequency alternating electric field with pretilt angle; continuing applying high frequency alternating electric field and using UV light for radiation so that reactive monomers polymerizing and polymers deposited on surfaces of the first alignment film and the second alignment film leading to fixing pretilt angle to perform alignment on liquid crystal molecules.

According to a preferred embodiment of the present invention, the liquid crystal molecules show negative liquid crystal characteristics in high frequency alternating electric field, and are arranged with long axis direction of liquid crystal molecules being perpendicular to direction of high frequency alternating electric field.

According to a preferred embodiment of the present invention, reactive monomers are arranged with long axis direction of reactive monomers perpendicular to high frequency alternating electric field, and reactive monomers in high frequency alternating electric field form liquid crystal alignment polymers and polymers are deposited on surfaces of the first alignment film and the second alignment film after radiation of UV light.

According to a preferred embodiment of the present invention, the pretilt angle is 0-5°.

According to a preferred embodiment of the present invention, frequency of high frequency alternating electric filed is equal to or higher than 1000 Hz.

The present invention provides a liquid crystal panel, which comprises: a first substrate, having surface disposed with a first alignment film; a first alignment film, disposed on surface of the first substrate facing second alignment film; a second substrate, disposed oppositely to the first substrate, having surface disposed with common electrodes and pixel electrodes, having a second alignment film covering common electrodes and pixel electrodes; liquid crystal molecules, disposed between the first alignment film and the second alignment film. Surfaces of the first alignment film and the second alignment film comprises liquid crystal alignment polymers to perform alignment on liquid crystal molecules so that liquid crystal molecules are arranged with a pretilt angle when no drive voltage is applied.

According to a preferred embodiment of the present invention, a drive voltage is provided by frequency alternating electric field, and liquid crystal molecules show positive liquid crystal characteristics in low frequency alternating electric field, and are arranged with long axis direction of liquid crystal molecules being parallel to direction of low frequency alternating electric field.

According to a preferred embodiment of the present invention, frequency of low frequency alternating electric filed is equal to or less than 240 Hz.

According to a preferred embodiment of the present invention, alignment on liquid crystal molecules is performed in high frequency alternating electric filed, the liquid crystal molecules show negative liquid crystal characteristics in high frequency alternating electric field, and are arranged with long axis direction of liquid crystal molecules being perpendicular to direction of high frequency alternating electric field.

According to a preferred embodiment of the present invention, frequency of high frequency alternating electric filed is equal to or higher than 1000 Hz.

According to a preferred embodiment of the present invention, liquid crystal alignment polymers are formed by reactive monomers in high frequency alternating electric field after UV light radiation.

According to a preferred embodiment of the present invention, in the high frequency alternating electric filed, reactive monomers are arranged with long axis direction of reactive monomers perpendicular to high frequency alternating electric field.

According to a preferred embodiment of the present invention, the pretilt angle is 0-5°.

In summary, the liquid crystal panel and the method of liquid crystal alignment of the present invention use high frequency alternating electric field to make reactive monomers and liquid crystal molecules to be arranged in pretilt angle, and then use UV light radiation to fix the pretilt angle to as to realize alignment of the liquid crystal molecules. Because no rubbing alignment is used, no pollution will affect liquid crystal panel, and no static electricity is generated to cause damages and light leakage.

Furthermore, the alignment method of the present invention can control the pretilt angle more precisely to realize better dark state display and fast response time so as to improve the contrast and response speed of liquid crystal panel.

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort.

### BRIEF DESCRIPTION OF THE DRAWINGS

FIG. 1 is a flowchart showing the method of liquid crystal alignment according to the present invention;

FIG. 2 is a schematic view showing the structure of the liquid crystal panel of the present invention prior to alignment;

FIG. 3 is a schematic view showing the application of high frequency alternating electric field on liquid crystal panel during alignment according to the present invention;

FIG. 4 is a schematic view showing the application of UV radiation on liquid crystal panel during alignment according to the present invention;

FIG. 5 is a schematic view showing the structure of the liquid crystal panel of the present invention after alignment; and

FIG. 6 is a schematic view showing the liquid crystal panel in operation according to the present invention.

### DETAILED DESCRIPTION OF THE PREFERRED EMBODIMENTS

The following provides a clear and complete description of the technical solution according to the present invention using the drawing and the embodiment. Apparently, the drawings described below show only example embodiments of the present invention, instead of all embodiments. For other embodiments based on the disclosed drawings and embodiments, and obtained by those having ordinary skills in the art without paying any creative effort are also within the scope of the present invention.

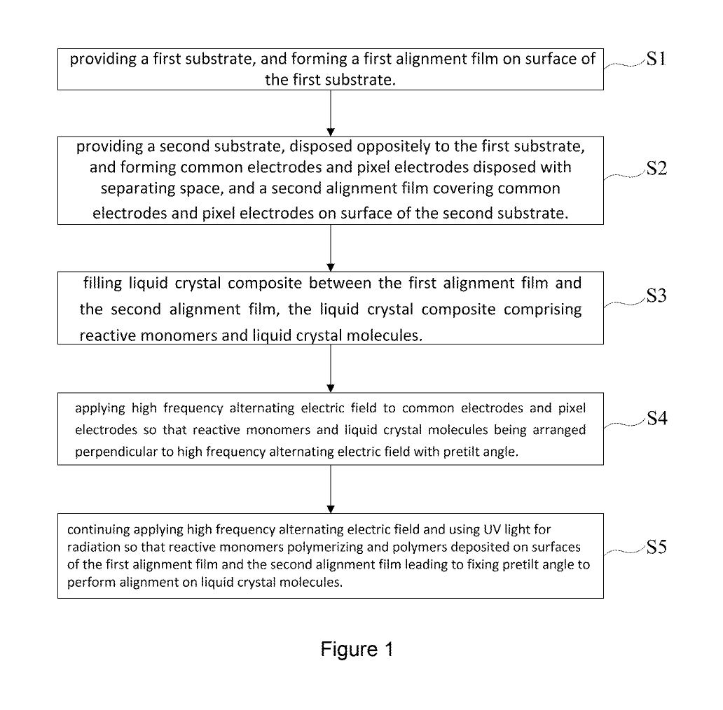

FIG. 1 is a flowchart showing the method of liquid crystal alignment according to the present invention. As shown in FIG. 1, the method of liquid crystal alignment of the present invention comprises the steps of:

Step S1: providing a first substrate, and forming a first alignment film on surface of the first substrate.

Step S2: providing a second substrate, disposed oppositely to the first substrate, and forming common electrodes and pixel electrodes disposed with separating space, and a second alignment film covering common electrodes and pixel electrodes on surface of the second substrate.

Step S3: filling liquid crystal composite between the first alignment film and the second alignment film, the liquid crystal composite comprising reactive monomers and liquid crystal molecules.

Step S4: applying high frequency alternating electric field to common electrodes and pixel electrodes so that reactive monomers and liquid crystal molecules being arranged perpendicular to high frequency alternating electric field with pretilt angle.

Step S5: continuing applying high frequency alternating electric field and using UV light for radiation so that reactive monomers polymerizing and polymers deposited on surfaces of the first alignment film and the second alignment film leading to fixing pretilt angle to perform alignment on liquid crystal molecules.

The following will refer to schematic views of the structure of the liquid crystal panel of the present invention prior to alignment, during alignment and after alignment to describe the above method of liquid crystal alignment.

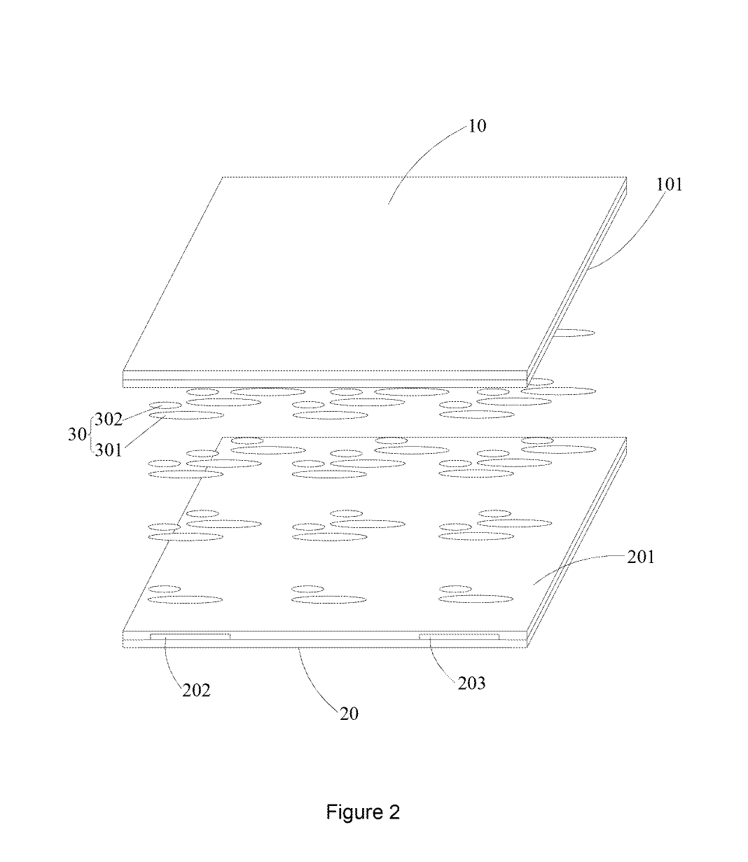

Referring to FIG. 2, FIG. 2 a schematic view showing the structure of the liquid crystal panel of the present invention prior to alignment.

Prior to alignment of liquid crystal panel, first, a first substrate 10 is provided and a first alignment film 101 is formed on first substrate 10.

In the instant embodiment, first substrate is a color filter substrate.

Then, a second substrate 20, disposed oppositely to first substrate 10, is provided. Common electrodes 202 and pixel electrodes 203, disposed with separating space, and a second alignment film 201 covering common electrodes 202 and pixel electrodes 203 are formed on second substrate 20.

In the instant embodiment, second substrate 20 is an array substrate. Common electrodes 202 and pixel electrodes 203 can be made of good light transmittance and conductive materials, such as, ITO, ZnO, IZO.

Liquid crystal composite 30 fills the space between first alignment film 101 and second alignment film 201. Liquid crystal composite 30 comprises liquid crystal molecules 301 and reactive monomers 302.

Liquid crystal molecules 301 show a characteristic, called dielectric anisotropy, of showing specific orientation when a specific voltage is applied. Values of dielectric anisotropy can be positive or negative, and dielectric anisotropy of liquid crystal molecules 301 varies with frequency of drive electric field; wherein the characteristic is called negative liquid crystal characteristic when dielectric anisotropy is negative, and the characteristic is called positive liquid crystal characteristic when dielectric anisotropy is positive.

In the instant embodiment, liquid crystal molecule 301 has dual-frequency characteristics. More specifically, liquid crystal molecule 301 shows negative liquid crystal characteristic in high frequency alternating electric field, and liquid crystal molecule 301 are arranged with long axis direction of liquid crystal molecule 301 being perpendicular to direction of high frequency alternating electric field. On the other hand, liquid crystal molecule 301 shows positive liquid crystal characteristic in low frequency alternating electric field, and liquid crystal molecule 301 are arranged with long axis direction of liquid crystal molecule 301 being parallel to direction of low frequency alternating electric field.

In the instant embodiment, reactive monomers 302 at least must show negative liquid crystal characteristic in high frequency alternating electric field. In other words, reactive monomers 302 are arranged with long axis direction of reactive monomers 302 being perpendicular to high frequency alternating electric field. It should be understood that monomer with dual-frequency characteristic can also be selected as reactive monomer 302. That is, in high frequency alternating electric field, reactive monomers 302 are arranged with long axis direction of reactive monomers 302 being perpendicular to high frequency alternating electric field; while in low frequency alternating electric field, reactive monomers 302 are arranged with long axis direction of reactive monomers 302 being parallel to low frequency alternating electric field.

Reactive monomer 302 can be Acrylate resin monomer molecule, Methacrylate resin monomer molecule, Vinyl resin monomer molecule, Vinyloxy resin monomer molecule or epoxy resin monomer molecule.

With polymer-stabilizing alignment (PSA) technique, reactive monomer 302 can polymerize to form polymers deposited on surfaces of first substrate and second substrate to guide liquid crystal molecules 301 to form arrangement, and form pretilt angle with substrates, described in details as follows.

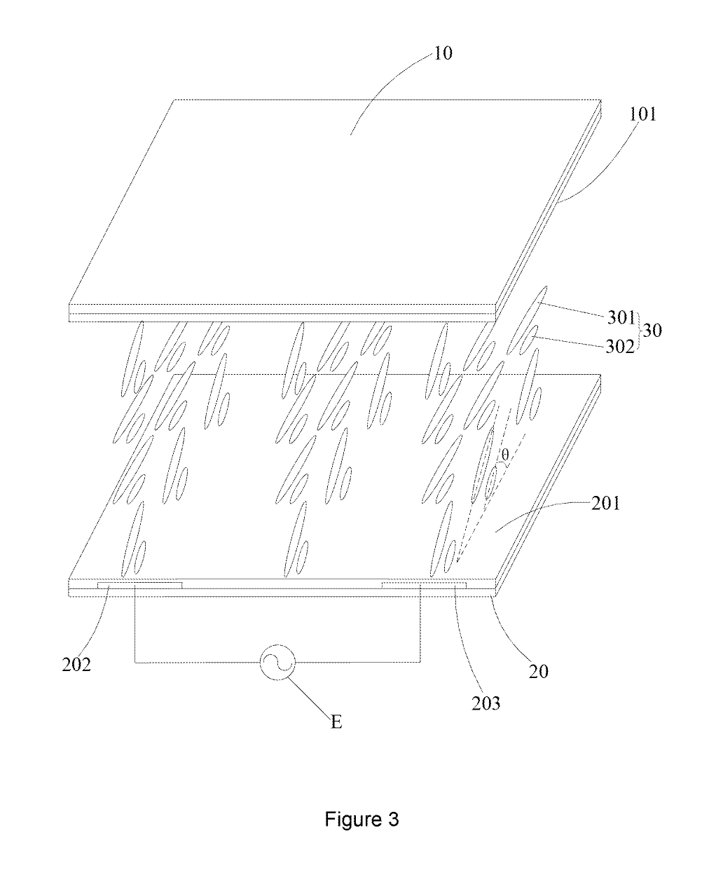

Referring also to FIG. 3, FIG. 3 is a schematic view showing the application of high frequency alternating electric field on liquid crystal panel during alignment according to the present invention.

In the instant embodiment, by applying high frequency alternating electric field E on common electrode 202 and pixel electrode 203, reactive monomer 302 and liquid crystal molecule 301 are made to line up perpendicularly to direction of high frequency alternating electric field E with a pretilt angle θ. In the instant embodiment, frequency of high frequency alternating electric field E is equal to or higher than 1000 Hz. In other alternative embodiments, the frequency of high frequency alternating electric field E can depend on the actual application.

Based on the dual frequency characteristic of liquid crystal molecule 301, in combination with the fact that drive voltage for liquid crystal panel operation is usually low frequency alternating electric field, in the instant embodiment, alignment voltage is provided by high frequency alternating electric field when performing alignment on liquid crystal molecule 301, and drive voltage to drive liquid crystal molecule 301 when operating liquid crystal panel is provided by low frequency alternating electric field.

After applying high frequency alternating electric field E on common electrode 202 and pixel electrode 203, electric field between first substrate 10 and second substrate 20 is in horizontal direction. At this point, because both reactive monomer 302 and liquid crystal molecule 301 show negative liquid crystal characteristic, both reactive monomer 302 and liquid crystal molecule 301 are arranged with long axis perpendicular to direction of high frequency alternating electric field E. Therefore, reactive monomers 302 are arranged with pretilt angle θ close to surface of first alignment film 101 and second alignment film 201.

Pretilt angle θ is the angle between reactive monomer 302 and first substrate 10 or second substrate 20. Specifically, Pretilt angle θ is the angle between long axis of reactive monomer 302 and surface of first alignment film 101 or second alignment film 202. In the instant embodiment, pretilt angle θ is preferably 0-5°.

Because Van der waals force exists between liquid crystal molecule 301 and reactive monomer 302, liquid crystal molecules 301 are also arranged with pretilt angle θ under the influence of Van der waals force.

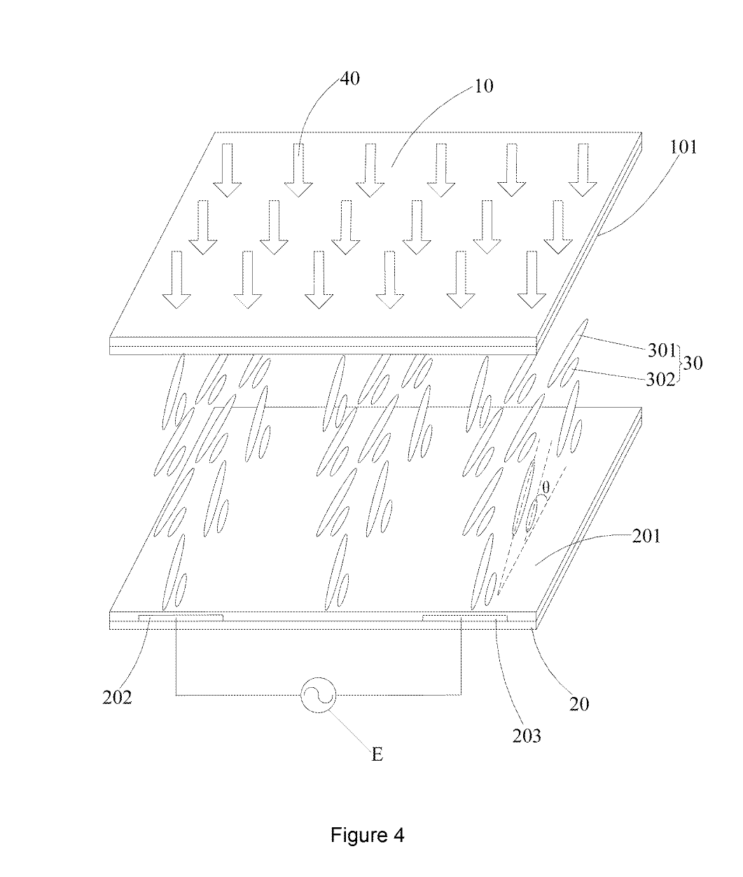

Referring also to FIG. 4, FIG. 4 is a schematic view showing the application of UV radiation on liquid crystal panel during alignment according to the present invention.

After reactive monomers 301 and liquid crystal molecules 302 are arranged, high frequency alternating electric field E is continuously applied, and UV radiation is also applied.

In the instant embodiment, UV light 40 radiates from a side of first substrate 10. When UV light 40 radiates, reactive monomers 302 polymerize. UV light within a certain range of wavelength can enable reactive monomers 302 to fully react without damaging liquid crystal molecules 301.

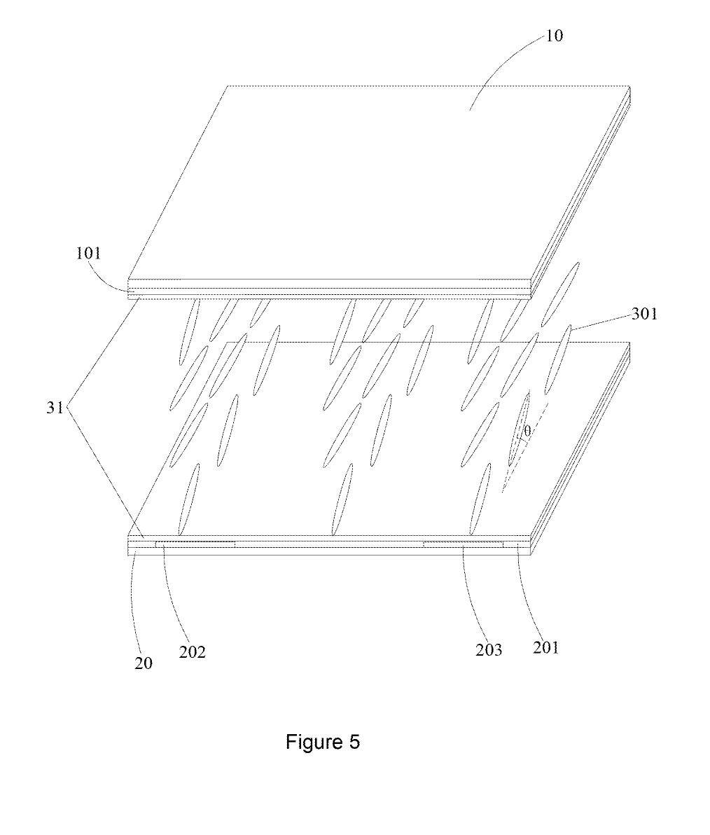

Reactive monomers 302 in high frequency alternating electric field E, after UV light 40 radiation, will form liquid crystal alignment polymer's 31 (as shown in FIG. 5) and polymers 31 are deposited on surfaces of first alignment film 101 and second alignment film 201 to guide arrangement of liquid crystal molecules 301 and forming pretilt angle θ with substrates.

In the instant embodiment, the process of reactive monomers 302 solidifying and deposited after UV light 40 radiation is called UV photo-alignment, or simply photo-alignment.

Photo-alignment uses anisotropic UV to radiate the alignment film to cause reactive monomers to polymerize to solidify and deposit on the alignment film, and also triggers non-uniform photo-polymerization, conversion or cleavage reaction to occur on the structure of reactive monomers on surface of alignment film to form liquid crystal alignment polymers, resulting in surface of alignment film generating anisotropic distributed Van der waals force to induce the liquid crystal molecules to line up.

In the instant embodiment, when applying high frequency alternating electric field E, because reactive monomers 302 close to surfaces of first alignment film 101 and second alignment film 201 are arranged with pretilt angle θ, pretilt angle θ is still maintained by high frequency alternating electric field E during solidification and deposition, and pretilt angle θ is fixed after liquid crystal alignment polymers 31 are formed. Because of Van der waals force, pretilt angle θ of liquid crystal molecules 301 is still maintained to accomplish the alignment of liquid crystal molecules 301.

Furthermore, in the present invention, through adjusting incident angle of UV light 40 and radiation time, pretilt angle θ can be precisely controlled to achieve better quality dark state and result in higher contrast and faster response time of liquid crystal panel.

Referring to FIG. 5, FIG. 5 is a schematic view showing the structure of the liquid crystal panel of the present invention after alignment.

After finishing alignment of liquid crystal molecules 301, liquid crystal panel also has a fixed structure, which comprises: a first substrate 10, a first alignment film 101, a second substrate 20, a second alignment film 201, common electrodes 202, pixel electrodes 203 and liquid crystal molecules 301.

First alignment film 101 is disposed on surface of first substrate 10. Second substrate 20 is disposed oppositely to first substrate 10. Common electrodes 202 and pixel electrodes 203 are disposed on surface of second substrate 20, with separating space. Second alignment film 201 is disposed on surface of second substrate 20, and covers common electrodes 202 and pixel electrodes 203. Liquid crystal molecules 301 are disposed between first alignment film 101 and second alignment film 201. Because common electrodes 202 and pixel electrodes 203 are both disposed on second substrate 20, the liquid crystal panel of the present invention corresponds to IPS display mode.

Surfaces of first alignment film 101 and second alignment film 201 are disposed with liquid crystal alignment polymers 31, which are formed through solidification and deposition resulted from reactive monomers 302 polymerization in high frequency electric field with UV radiation. Liquid crystal alignment polymers 31 can perform alignment on liquid crystal molecules 301 so that liquid crystal molecules 301 are arranged with pretilt angle θ when no drive voltage is applied. In the present embodiment, pretilt angle θ is 0-5°.

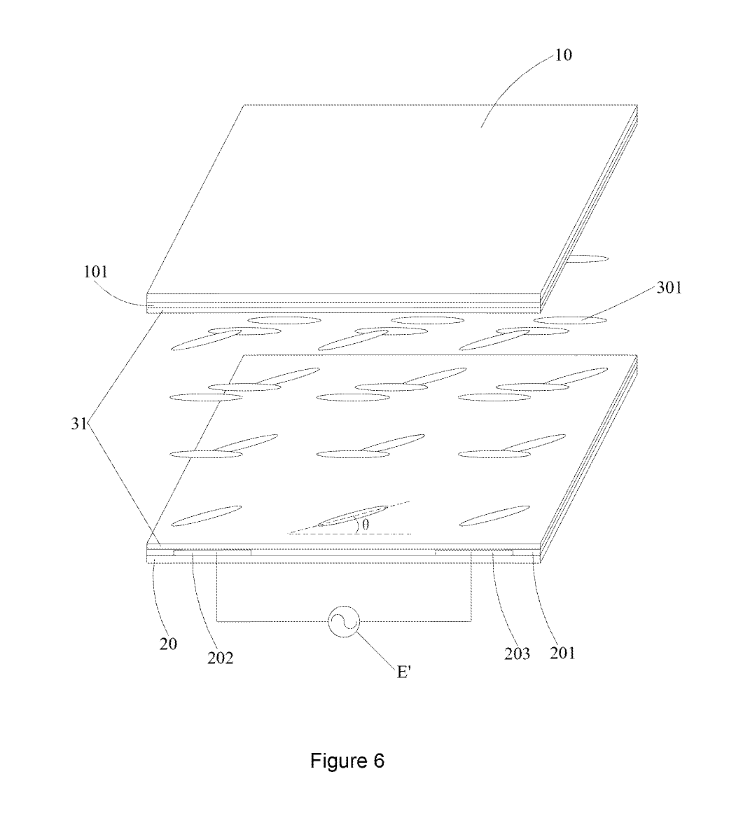

Referring to FIG. 6, FIG. 6 is a schematic view showing the liquid crystal panel in operation according to the present invention.

After finishing alignment, when liquid crystal panel is operating, low frequency alternating electric field E′ is applied to common electrodes 202 and pixel electrodes 203. In the instant embodiment, frequency of low frequency alternating electric field E′ is equal to or less than 240 Hz. In other embodiments, frequency of low frequency alternating electric field E′ can be determined according to appropriate requirements.

At this point, liquid crystal molecules 301 show positive liquid crystal characteristic in low frequency alternating electric field E′, and liquid crystal molecules are driven to line up with long axis parallel to direction of low frequency alternating electric field E′.

In operation, through applying low frequency alternating electric, field E′ to control polarization of liquid crystal molecules 301. The extent of polarization of liquid crystal molecules depends on low frequency alternating electric field E′. Meanwhile, polarization angle of liquid crystal molecules 301 determines the transmittance of light, and different polarization angle of liquid crystal molecules 301 generates different grayscale to accomplish displaying.

It is noted that in the above embodiments, only two common electrodes 202 and pixel electrodes 203, which are disposed with separating space, are marked. It should be understood that the embodiments of the present invention are illustrative, instead of restrictive. Embodiments of using a plurality of common electrodes 202 and pixel electrodes 203, and arranged with separating space in parallel or interleaving manner, are also within the scope of the present invention.

Through the above manner, the method of liquid crystal alignment and the liquid crystal panel of the present invention use high frequency alternating electric field to make reactive monomers and liquid crystal molecules to be arranged in pretilt angle, and then use UV light radiation to fix the pretilt angle to as to realize alignment of the liquid crystal molecules for IPS display mode liquid crystal panel. Because no rubbing alignment is used, no pollution will affect liquid crystal panel, and no static electricity is generated to cause damages and light leakage. Furthermore, the alignment method of the present invention can control the pretilt angle more precisely to realize better dark state display and fast response time so as to improve the contrast and response speed of liquid crystal panel.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A method of liquid crystal alignment, which comprises:
providing a first substrate, and forming a first alignment film on surface of the first substrate;
providing a second substrate, disposed oppositely to the first substrate, and forming common electrodes and pixel electrodes disposed with separating space, and a second alignment film covering common electrodes and pixel electrodes on surface of the second substrate;
filling liquid crystal composite between the first alignment film and the second alignment film, the liquid crystal composite comprising reactive monomers and liquid crystal molecules, wherein liquid crystal molecules showing negative liquid crystal characteristics in high frequency alternating electric field, and arranged with long axis direction of liquid crystal molecules being perpendicular to direction of high frequency alternating electric field; reactive monomers arranged with long axis direction of reactive monomers being perpendicular to high frequency alternating electric field, and reactive monomers in high frequency alternating electric field forming liquid crystal alignment polymers and polymers being deposited on surfaces of the first alignment film and the second alignment film after radiation of UV light;
applying high frequency alternating electric field to common electrodes and pixel electrodes so that reactive monomers and liquid crystal molecules being arranged perpendicular to high frequency alternating electric field with pretilt angle; and
continuing applying high frequency alternating electric field and using UV light for radiation so that reactive monomers polymerizing and polymers deposited on surfaces of the first alignment film and the second alignment film leading to fixing pretilt angle to perform alignment on liquid crystal molecules.

2. The method of liquid crystal alignment as claimed in claim 1, characterized in that the pretilt angle is 0-5°.

3. The method of liquid crystal alignment as claimed in claim 1, characterized in that frequency of high frequency alternating electric filed is equal to or higher than 1000 Hz.

4. A method of liquid crystal alignment, which comprises:
providing a first substrate, and forming a first alignment film on surface of the first substrate;
providing a second substrate, disposed oppositely to the first substrate, and forming common electrodes and pixel electrodes disposed with separating space, and a second alignment film covering common electrodes and pixel electrodes on surface of the second substrate;
filling liquid crystal composite between the first alignment film and the second alignment film, the liquid crystal composite comprising reactive monomers and liquid crystal molecules;
applying high frequency alternating electric field to common electrodes and pixel electrodes so that reactive monomers and liquid crystal molecules being arranged perpendicular to high frequency alternating electric field with pretilt angle; and
continuing applying high frequency alternating electric field and using UV light for radiation so that reactive monomers polymerizing and polymers deposited on surfaces of the first alignment film and the second alignment film leading to fixing pretilt angle to perform alignment on liquid crystal molecules.

5. The method of liquid crystal alignment as claimed in claim 4, characterized in that the liquid crystal molecules show negative liquid crystal characteristics in high frequency alternating electric field, and are arranged with long axis direction of liquid crystal molecules being perpendicular to direction of high frequency alternating electric field.

6. The method of liquid crystal alignment as claimed in claim 4, characterized in that reactive monomers are arranged with long axis direction of reactive monomers perpendicular to high frequency alternating electric field, and reactive monomers in high frequency alternating electric field form liquid crystal alignment polymers and polymers are deposited on surfaces of the first alignment film and the second alignment film after radiation of UV light.

7. The method of liquid crystal alignment as claimed in claim 4, characterized in that the pretilt angle is 0-5°.

8. The method of liquid crystal alignment as claimed in claim 4, characterized in that frequency of high frequency alternating electric filed is equal to or higher than 1000 Hz.

9. A liquid crystal panel, which comprises:
a first substrate, having surface disposed with a first alignment film;
a second substrate, disposed oppositely to the first substrate, having surface disposed with common electrodes and pixel electrodes, having a second alignment film covering common electrodes and pixel electrodes; and
liquid crystal molecules, disposed between the first alignment film and the second alignment film;
wherein surfaces of the first alignment film and the second alignment film comprising liquid crystal alignment polymers to perform alignment on liquid crystal molecules so that liquid crystal molecules being arranged with a pretilt angle when no drive voltage being applied.

10. The liquid crystal panel as claimed in claim 9, characterized in that a drive voltage is provided by frequency alternating electric field, and liquid crystal molecules show positive liquid crystal characteristics in low frequency alternating electric field, and are arranged with long axis direction of liquid crystal molecules being parallel to direction of low frequency alternating electric field.

11. The liquid crystal panel as claimed in claim 10, characterized in that frequency of low frequency alternating electric filed is equal to or less than 240 Hz.

12. The liquid crystal panel as claimed in claim 9, characterized in that alignment on liquid crystal molecules is performed in high frequency alternating electric filed, the liquid crystal molecules show negative liquid crystal characteristics in high frequency alternating electric field, and are arranged with long axis direction of liquid crystal molecules being perpendicular to direction of high frequency alternating electric field.

13. The liquid crystal panel as claimed in claim 12, characterized in that frequency of high frequency alternating electric filed is equal to or higher than 1000 Hz.

14. The liquid crystal panel as claimed in claim 12, characterized in that liquid crystal alignment polymers are formed by reactive monomers in the high frequency alternating electric field after UV light radiation.

15. The liquid crystal panel as claimed in claim 14, characterized in that in the high frequency alternating electric filed, the reactive monomers are arranged with long axis direction of reactive monomers perpendicular to the high frequency alternating electric field.

16. The liquid crystal panel as claimed in claim 9, characterized in that the pretilt angle is 0-5°.
